(19) United States
(12) Patent Application Publication
(10) Pub. No.: US 2024/0241060 A1
(43) Pub. Date: Jul. 18, 2024

(54) SYSTEM, METHOD AND CONSUMPTION PRODUCT FOR A CHEMICAL, BIOCHEMICAL OR IMMUNOCHEMICAL DETECTION PROCESS

(71) Applicant: Innovative Sensor Technology IST AG, Ebnat-Kappel (CH)

(72) Inventors: Florian Krogmann, Kreuzlingen (CH); Gerhard Jobst, Freiburg (DE); Elmara Graser, Berlin (DE); Timo Hillebrand, Hönow (DE); Isabella Moser, Eichstetten a. K. (DE)

(21) Appl. No.: 18/557,334

(22) PCT Filed: Apr. 8, 2022
(86) PCT No.: PCT/EP2022/059362

§ 371 Date: Oct. 26, 2023

(30) Foreign Application Priority Data
Apr. 28, 2021 (DE) 10 2021 110 828.4

(51) Int. Cl. G01N 21/84; B01L 7/00; G01N 21/77; G01N 21/78

(52) U.S. Cl. CPC G01N 21/8483; B01L 7/52; G01N 21/78; B01L 2300/025; B01L 2300/0663; B01L 2300/0825; G01N 2021/7759; G01N 2021/7786

(57) ABSTRACT

A system and a method for a chemical, biochemical or immunochemical detection process includes: a consumption product configured to be introduced into a steam generator and including a test module configured for receiving a biological sample and for performing a biochemical or immunochemical detection process or configured as a reaction vessel for performing a chemical, biochemical or immunochemical detection process on the biological sample; the steam generator including a detection element configured for recording a result or a stage in the progress of the detection process when the consumption product is introduced into the steam generator; and at least one output module configured for outputting the result or the stage in the progress of the chemical, biochemical or immunochemical detection process.

The invention relates to a system for a chemical, biochemical or immunochemical detection process. The invention further relates to a method for carrying out a chemical, biochemical or immunochemical detection process. The invention further relates to a consumption product for a steam generator which is designed for use in the method according to the invention.

A multitude of hand-held, steam-generating devices for consumption, referred to hereinafter as steam generators, are known from the prior art. All of these steam generators have in common that they are designed to receive a consumption product or “consumable” containing a solid or liquid medium which is heated by the steam generator so that it assumes a gaseous state or an aerosol form. This steam is subsequently inhaled by a consumer or user.

An example of such steam generators are electronic cigarettes or evaporators. Their consumption products contain a liquid which is evaporated. Such liquids can either contain nicotine, or they can be nicotine-free and contain tea, for example.

Another example of such steam generators is so-called tobacco heaters, in particular heat-not-burn products. Heat-not-burn (HnB) tobacco products are an alternative to conventional cigarettes. They use heating elements installed in a heating chamber to heat the tobacco instead of burning it. The result of heating is a nicotine-containing aerosol which is inhaled by the user. HnB products differ from other types of steam generators in that genuine tobacco is heated instead of a liquid containing nicotine. For this purpose, the consumption product is designed as a tobacco stick, which is inserted into a heating chamber of the HnB product, is typically pierced by the heating element and is subsequently heated by the heating element or walls of the heating chamber.

All HnB products commercially available (for example, “IQOS” from PMI, “LilPlus” from KT&G; “Glo” from BAT, “IUOC 2” from SYT, “Monk” from CT, etc.) and further types of steam generators use electronically controlled heating elements based on resistive (Joule) heating.

Many of these steam generators have been developed to provide a user with a less harmful alternative to conventional cigarette consumption. A health aspect therefore plays a role for many of the users. However, the steam generators do not serve any further purpose other than to evaporate the media contained in the consumption product.

The object of the invention is to provide an application for a steam generator that enables statements to be made regarding health aspects of the user.

The object is achieved by a system according to claim 1, by a method according to claim 14, and by a consumption product according to claim 16.

As regards the system, it is provided for the system to be suitable for a chemical, biochemical or immunochemical detection process, the system comprising:
a consumption product, which is designed for being introduced into a steam generator, wherein the consumption product has a test module, wherein the test module is designed for receiving a biological sample and wherein the test module is designed for carrying out a biochemical or immunochemical detection process or as a reaction vessel for a chemical, biochemical or immunochemical detection process with respect to the biological sample;
a steam generator with a receptacle for the consumption product, wherein the steam generator comprises a detection element, wherein the detection element is designed for recording a result or a stage in the progress of the chemical, biochemical or immunochemical detection process when the consumption product is introduced into the receptacle of the steam generator; and at least one output module, which is designed for outputting a result or a stage in the progress of the chemical, biochemical or immunochemical detection process.

The invention consists of a combination of a modified consumption product (consumable) and a modified steam generator. Unlike conventionally used consumption products, the consumption product does not contain any vaporizable medium, but a test module. The steam generator has a corresponding detection element for recording a result or a stage in the progress of the detection process, and an output module for outputting this result or progress.

For ingestion of the biological sample, the consumption product is brought up to the user's mouth or lips. This corresponds to the user's normal consumption behavior for a conventional consumption product, so that no refamiliarization of the user is required here and the acceptance threshold is lowered.

Alternatively, it can be provided for the biological sample of the user to be prepared or processed before it comes into contact with the consumption product. For example, the user first puts saliva into a vessel contained with corresponding reagents, mixes the biological sample and the reagents and then brings this mixture into contact with the consumption product.

According to an advantageous embodiment of the system according to the invention, it is provided for the steam generator to comprise a heating element for heating at least the test module. The heating element is standardly included in a steam generator. The heating module is, for example, a heating plate made of a ceramic substrate, onto which a resistance structure is applied as an active heating element by a thick-film or thin-film process.

The steam generator can furthermore comprise a temperature sensor. Alternatively, such a temperature sensor can be installed in the heating module itself, for example, in the form of a further resistance structure. The heating module and the temperature sensor are connected to a controller to form a control circuit. As a result, a desired temperature inside the steam generator can be set via the heating module.

Depending on the precise chemical, biochemical or immunochemical detection process, which is enabled by the respective consumption product, various synergistic effects between the heating module and the test module are made possible, which will be discussed in the following sections.

A first variant of the system according to the invention provides for the test module to be a chromatographic test strip. Such a chromatographic test strip, referred to also as test frit, enables a wide variety of embodiments of chemical, biochemical or immunochemical detection processes. The chromatographic test strip is in particular a lateral flow test. Lateral flow tests are inexpensive and easy-to-use rapid medical tests and are basically a combination of thin-layer chromatography and immunostaining. After having been applied to a sample region of the test strip (in the present case, the region of the consumption product which comes into contact with the user's lips or mouth or breath), the biological sample disperses on the test strip together with a mobile phase due to capillary forces. After the relevant sample molecules (for example, antibodies) bind with immunoconjugates in the test strip, the sample migrates into a detection region in which the immunoconjugates bind to corresponding sites, and a discoloration occurs, usually in the form of a stripe. In most cases, there is additionally a second stripe in the detection region, which is used as a negative control without sample and rules out false-positive results.

There is a plurality of applications for such chromatographic test strips which can be used with the system according to the invention. Non-limiting examples include pregnancy tests, allergy tests and antibody tests (for example, for the detection of SARS-CoV 2).

Many of these chromatographic test strips are temperature dependent. For example, sensitivity is increased within a certain temperature range, while it decreases outside this temperature range. The temperature can be regulated to the optimum temperature range by means of the heating element of the steam generator. For this purpose, it may be provided for the consumption product to include an item of information about the temperature range (for example, as an imprint) which the user communicates to the steam generator via an input option (e.g., buttons or via an external operating unit, for example, via an app in the smartphone), so that the steam generator regulates the temperature accordingly by means of the heating element. The temperature range can also be attached to the consumption product in the form of a code (e.g., barcode or QR code) and can be read in optically by the steam generator or the external operating unit in order to record the item of information.

According to an advantageous embodiment of the first variant of the system according to the invention, it is provided for the detection element to be a CCD sensor, in particular a 4-pixel or 16-pixel CCD sensor. The stripes in the detection region of the chromatographic test strip are detected with the CCD sensor. As a result, both the result stripe and the second stripe for the negative control can be reliably recorded.

A second variant of the system according to the invention provides for the heating module to be designed for carrying out an amplification by heating the test module. As described above, the heating element is integrated here in particular in a control circuit. For this purpose, the biological sample contains DNA or RNA, which is thereby amplified, or DNA or RNA contained microorganisms (bacteria, fungi, etc.) or viruses. The exact parameters for carrying out the amplification (number of cycles (1 to n), maximum temperature per cycle, ascending and descending temperature ramp, time between cycles, temperature between cycles, etc.) are input by the user analogously to the above regarding the chromatographic test strip, or read in analogously to the above regarding the chromatographic test strip.

All chemicals required for amplification are lyophilized in the corresponding test module. For this purpose, for example, a lyophilized PCR master mix (containing primer/probes OneStep RT-PCR, or PCR enzymes, dNTPs and all necessary buffer substances) is used.

According to an advantageous embodiment of the second variant of the system according to the invention, it is provided for the amplification to be an isothermal amplification. In this variant, the temperature is continuously driven to a prespecified value and held for a certain time.

According to a further advantageous embodiment of the second variant of the system according to the invention, it is provided for the heating element to be designed for heating the test module in prespecified heating cycles and for carrying out a polymerase chain reaction. In this case, various heating cycles are run (each with the same or a different temperature). As described above, the heating element is integrated here in particular in a control circuit.

According to an advantageous embodiment of the system according to the invention, it is provided for the result or progress to be a light signal emitted or reflected by the test module, in particular a color change or a fluorescence signal. In the case of a chromatographic test strip, two stripes produced by color changes are generally produced as a result. With the various types of amplification, the progress or the result can be detected via the intensity of the reflection or fluorescence.

According to an advantageous embodiment of the system according to the invention, it is provided for the detection element to be designed for recording the light signal emitted or reflected by the test module. It is in particular a camera, an (already described) CCD sensor or a simple photodiode (if no spatial resolution is required).

According to an advantageous embodiment of the system according to the invention, it is provided for the heating module to be designed for heating the sample for the purpose of preparation before carrying out the reaction. In this way, thermal lysis can be carried out in order to release the DNA or RNA in the microorganisms or viruses. For example, a biological sample containing salmonella is heated to 95° C. for a certain period of time.

According to an advantageous embodiment of the system according to the invention, it is provided for the steam generator to have an element for preparing the sample and/or for purifying products of the chemical, biochemical or immunochemical detection process. Especially for amplification processes, it is necessary for the biological sample to be processed at the beginning (for example by chemical lysis methods, etc.). The element is, for example, a chamber in the steam generator, in which corresponding reagents and/or substances are stored. For digestion of the DNA-containing cells and release of the nucleic acids containing therein, alkaline lysis and subsequent neutralization and purification of the sample from the non-lysed cell components are carried out by means of a filtration. For this purpose, the element can be equipped with a cartridge or a lateral flow system and chemicals lyophilized therein. This process is known to the person skilled in the art (see, for example, I. Rudbeck, J. Dissing. Rapid, Simple Alkaline Extraction of Human Genomic DNA from Whole Blood, Buccal Epithelial Cells, Semen and Forensic Stains for PCR. BioTechniques 25:588-592 (October 1998)] and is used in several commercial kits.

Furthermore, the element can include a passive or active conveying means (for example, a pump, for example, a peristaltic micropump) in order to be able to convey the reagents, substances or the sample itself between the element and the test module.

According to an advantageous embodiment of the system according to the invention, it is provided for the output module to be an optical output module, in particular an LED or display. In the event that the result of the detection process is a binary result (e.g., “positive” and “negative”), this can be indicated by a single LED. In addition to the result, the progress of the detection process can additionally be displayed by means of a display or a plurality of LEDs.

According to an alternative advantageous embodiment of the system according to the invention, it is provided for the output module to be a wireless communication interface, in particular designed according to one of the NFC/RFID, Bluetooth or WiFi standards. It may also be any other suitable wireless standard. The progress and/or the result can thus be transmitted to an operating unit (for example a smartphone with a corresponding app) which displays and advantageously analyzes and/or further processes the progress and/or the result.

According to an advantageous embodiment of the system according to the invention, it is provided for the steam generator to be an electronic cigarette, an evaporator, or a tobacco heater, in particular a heat-not-burn product. The steam generator is designed for heating a solid or liquid medium in a conventional consumption product such that it assumes a gaseous state or an aerosol form.

As regards the method, it is provided for the method to perform a chemical, biochemical or immunochemical detection process, comprising:
providing a consumption product, which is designed for being introduced into a steam generator, wherein the consumption product has a test module, wherein the test module is designed for receiving a biological sample and wherein the test module is designed for carrying out a biochemical or immunochemical detection process or as a reaction vessel for a chemical, biochemical or immunochemical detection process with respect to the biological sample;
introducing the consumption product into a receptacle of the steam generator, wherein the steam generator comprises a detection element;
recording a result or a stage in the progress of the chemical, biochemical or immunochemical detection process by means of the detection element; and
outputting a result or a stage in the progress of the chemical, biochemical or immunochemical detection process by means of an output module of the steam generator.

According to an advantageous embodiment of the method according to the invention, it is provided for a user to wet the test module for receiving the biological sample with saliva as the biological sample. For this purpose, the consumption product is brought up to the user's mouth or lips.

As regards the consumption product, it is provided for the latter to be suitable for a steam generator and to be designed for use the method according to the invention, wherein the consumption product has a test module, wherein the test module is designed for receiving a biological sample and wherein the test module is designed for carrying out a chemical, biochemical or immunochemical detection process or as a reaction vessel for a chemical, biochemical or immunochemical detection process with respect to the biological sample. The consumption product (consumable) is provided as a single-use product and, unlike conventional consumption products, contains no medium that can be heated to produce consumable steam.

The invention is explained in greater detail with reference to the following figures, in which:

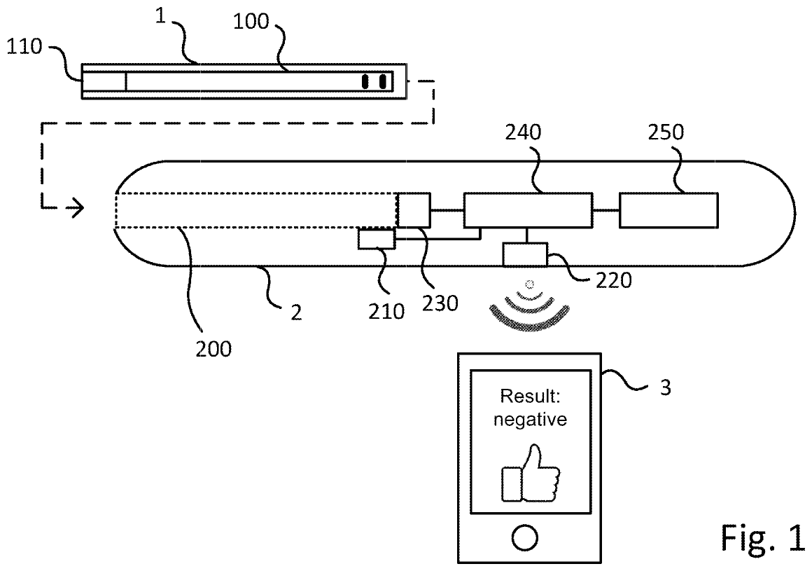

FIG. 1 shows a first exemplary embodiment of the system according to the invention; and

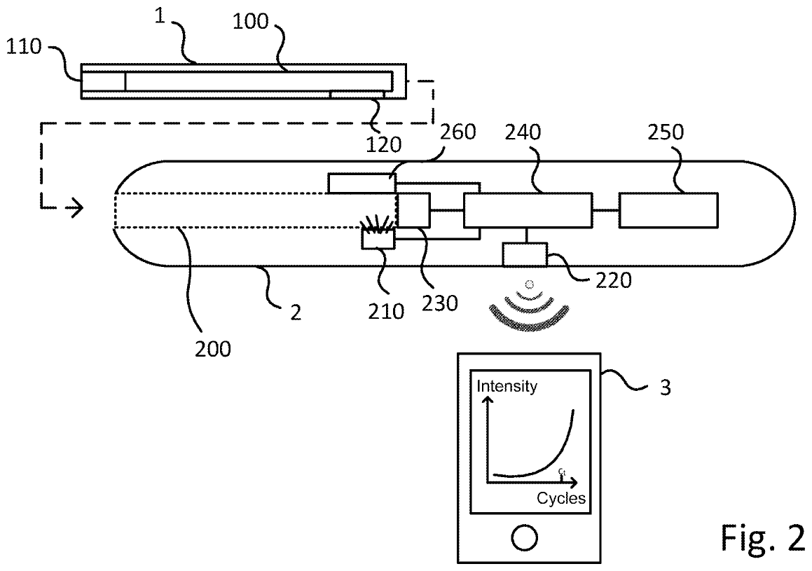

FIG. 2 shows a second exemplary embodiment of the system according to the invention.

FIG. 1 shows a first exemplary embodiment of the system according to the invention. The system consists of a steam generator 2 and a consumption product 1.

The consumption product 1 comprises a test module 100 in the form of a chromatographic test strip, more precisely a lateral flow test for detecting antibodies or antigens against SARS-CoV-2/COVID-19 in a biological sample. To take up the biological sample, specifically saliva, the user brings the consumption product 1 up to the mouth or lips, so that the receptacle or a mouthpiece 110 of the consumption product is wetted with saliva.

The consumption product 1 is subsequently pushed into a corresponding receptacle 200 of the steam generator 2. Alternatively, the consumption product is pushed into the receptacle of the steam generator 2 already before taking up the biological sample. The receptacle 200 is then designed such that the mouthpiece 110 protrudes and can be contacted with the user's mouth or lips.

The lateral flow test then carries out the detection process for the antibodies. Here, it may be provided for the heating element 230 of the steam generator 2 to regulate the test module to a prespecified temperature, for example 25° C. For this purpose, the heating element is connected in a control circuit to a temperature sensor and a controller.

The steam generator 2 has a detection element 210 in the form of a CCD sensor for recording the result of the detection process. The result consists in particular of two stripes resulting from a color change, wherein one of the stripes serves as a negative control.

Recording the result or heating the test module 100 is started, for example, by pressing a button on the steam generator 1. The steam generator 100 comprises operating electronics 240 which control the heating as well as the recording and processing of the result. A battery element 250 in the steam generator 2 supplies all relevant components of the steam generator 2 with electrical energy.

The result of the detection process recorded by the CCD sensor 210, or unprocessed information about this, is subsequently transmitted to an operating unit 3 via an output module 250, which is a Bluetooth interface or a similar wireless interface. In the present case, the operating unit 3 is a smartphone. An app on the smartphone receives and checks the information, calculates the result and then displays it. In the present case, the result is “negative,” i.e., no antibodies or antigens have been found and the user is considered healthy.

Alternatively or additionally, the output module 250 can also be a display or one or more LEDs, attached to the steam generator 2. In this case, the operating electronics 240 process the information recorded by the CCD sensor 210 and calculate the result independently in order to display it via the output module 250.

The chromatographic test strip is not limited to the application of antigen/antibody determinations (SARS-CoV-2) described but can be suitable for a plurality of different applications for antigen/antibody determination, for example as a pregnancy test or allergy test. Likewise, chemical detection processes can also be carried out by means of such chromatographic test strips, which processes produce a color change, for example, acetone detection by means of Fehling's solution (resulting in a red color change), detection of ketoacidosis or various methods for detecting alcohol or drugs.

FIG. 2 shows a second exemplary embodiment according to the invention. The consumption product 1 differs from the previously described consumption product in that it has no test strip as a test module 100 but has a reaction chamber for an amplification process. In addition, the consumption product has a transparent viewing window 120. Alternatively, the consumption product 1 consists entirely of a transparent material.

In the present case, the amplification process is a polymerase chain reaction (PCR). It serves, in turn, for the direct detection of SARS-CoV-2-RNA in the biological sample.

The biological sample, which is contained in the consumption product 1 pushed into the receptacle 200 of the steam generator 2, is first extracted and purified. For digestion of, for example, the DNA-containing cells and release of the nucleic acids containing therein, alkaline lysis and subsequent neutralization and purification of the sample from the non-lysed cell components are carried out by means of a filtration. For this purpose, an element 260 for preparing the sample and/or for purifying the sample can be provided, in which lyophilized chemicals are located.

The test module 100 is then cyclically heated according to a PCR protocol by means of the heating element 230. For this purpose, the heating element is connected in a control circuit to a temperature sensor and a controller in order to be able to accurately reach the prespecified temperatures. At the same time, light is emitted into the test module 100 with a prespecified excitation frequency by means of the detection element 210, and the corresponding fluorescence of the biological sample is recorded in each cycle. All chemicals required for amplification are provided in lyophilized form in the corresponding test module 100 region. Here, the sample purified/prepared from the element 260 can be amplified and simultaneously detected by the detection module.

The values of the fluorescence are transmitted continuously via the output module 250 to the smartphone 3 and processed. The app of the smartphone graphically represents the values of fluorescence over time and determines the so-called c, value which indicates the result of the detection process. In the present case, the c value is very high. I.e., no corresponding antibodies or antigens have been found which means that the user is considered healthy.

For both exemplary embodiments described in FIGS. 1 and 2, it can be provided for the operating parameters (chromatographic test strips: heating temperature and duration; amplification: number of cycles (1 to n), maximum temperature per cycle, ascending and descending temperature ramp, time between cycles, temperature between cycles, etc.) to be communicated to the steam generator via an input option (e.g., buttons or via an external controller 3, for example via an app in the smartphone).

Alternatively, the operating parameters can also be attached to the consumption product 1 in the form of a code (e.g., barcode or QR code) and can be read in optically by the steam generator 2 or the operating unit 3 in order to record the information.

### LIST OF REFERENCE SIGNS

1 Consumption product
100 Test module
110 Receptacle/mouthpiece
120 Viewing window
2 Steam generator
200 Receiving opening
210 Detection element
220 Output module
230 Heating element
240 Operating electronics
250 Battery element
260 Element for preparing the sample and/or for purification
3 Operating unit

1-17. (canceled)

18. A system for a chemical, biochemical or immunochemical detection process, the system comprising:
a consumption product, which is configured to be introduced into a steam generator, wherein the consumption product includes a test module, wherein the test module is configured to receive a biological sample, and
wherein the test module is configured to perform a biochemical or immunochemical detection process or is configured as a reaction vessel for a chemical, biochemical or immunochemical detection process with respect to the biological sample;
a steam generator, which includes a receiving opening configured to accept the consumption product, wherein the steam generator comprises a detection element configured to record a result or a stage of progress of the chemical, biochemical or immunochemical detection process when the consumption product is introduced into the receiving opening of the steam generator; and
at least one output module, which is configured to output the result or the stage of progress of the chemical, biochemical or immunochemical detection process.

19. The system according to claim 18, wherein the steam generator comprises a heating element adapted to heat at least the test module.

20. The system according to claim 19, wherein the heating element is adapted to perform amplification by heating the test module.

21. The system according to claim 20, wherein the amplification is an isothermal amplification.

22. The system according to claim 20, wherein the heating element is adapted to heat the test module in prespecified heating cycles and to perform a polymerase chain reaction.

23. The system according to claim 22, wherein the heating module is adapted to heat the sample for preparation before performing the polymerase chain reaction.

24. The system according to claim 18, wherein the test module is a chromatographic test strip.

25. The system according to claim 24, wherein the detection element is a CCD sensor.

26. The system according to claim 25, wherein the detection element is a 4-pixel or 16-pixel CCD sensor.

27. The system according to claim 18, wherein the result or stage of progress is a light signal emitted or reflected by the test module.

28. The system according to claim 27, wherein the result or stage of progress is a color change or a fluorescence signal.

29. The system according to claim 27, wherein the detection element is configured to record the light signal emitted or reflected by the test module.

30. The system according to claim 18, wherein the steam generator includes an element operative for preparing the sample and/or for purifying products of the chemical, biochemical or immunochemical detection process.

31. The system according to claim 18, wherein the output module is an optical output module.

32. The system according to claim 31, wherein the optical output module is an LED or a display.

33. The system according to claim 18, wherein the output module is a wireless communication interface.

34. The system according to claim 18, wherein the steam generator is an electronic cigarette, an evaporator, or a heat-not-burn device.

35. A method for performing a chemical, biochemical or immunochemical detection process, the method comprising:
providing a consumption product, which is configured to be introduced into a steam generator, wherein the consumption product includes a test module, wherein the test module is configured to receive a biological sample, and
wherein the test module is configured to perform a biochemical or immunochemical detection process or is configured as a reaction vessel for a chemical, biochemical or immunochemical detection process with respect to the biological sample;
introducing the consumption product into a receiving opening of the steam generator, wherein the steam generator comprises a detection element;
recording a result or a stage of progress of the chemical, biochemical or immunochemical detection process using the detection element; and
outputting a result or the stage of progress of the chemical, biochemical or immunochemical detection process via an output module of the steam generator.

36. The method according to claim 35, wherein a user of the method wets the test module with saliva as the biological sample.

37. A consumption product for a steam generator of an electronic cigarette, an evaporator, or a heat-not-burn device, the consumption product comprising:
a test module configured to receive a biological sample,
wherein the test module is configured to perform a chemical, biochemical or immunochemical detection process or is configured as a reaction vessel for a chemical, biochemical or immunochemical detection process with respect to the biological sample, and
wherein the consumption product is configured to be introduced into a steam generator.
